(19) United States
(12) Patent Application Publication
(10) Pub. No.: US 2003/0190056 A1
(43) Pub. Date: Oct. 9, 2003

(54) System and method for encoding and decoding data and position information using angular symbology and beacons

(76) Inventor: Eric Metois, Arlington, MA (US)

Correspondence Address: CESARI AND MCKENNA, LLP, 88 BLACK FALCON AVENUE, BOSTON, MA, 02210, US

(21) Appl. No.: 10/409,959

(22) Filed: Apr. 9, 2003

Related U.S. Application Data
(60) Provisional application No. 60/371,077, filed on Apr. 9, 2002.

(51) Int. Cl. G06K 9/00; G06K 9/36

(52) U.S. Cl. 382/100; 382/232

(57) ABSTRACT

A system for encoding position-related information in and determining the relative position of a reader from a coded pattern represents the position-related information as modulation patterns that are radially symmetrical about respective center points having known locations. The position modulation patterns in a portion of the coded pattern have angular orientations with respect to a reference orientation which is associated with a reference modulation pattern. Based on the angular orientations of the respective position modulation patterns, the relative position of, for example, a reader in the coded pattern can then be determined. The position modulation patterns are selected to have components that are localized in a Fourier transform domain. An example of a position modulation pattern is a radially symmetrical sinusoidal pattern in which spatial frequency and angular orientation are localized in the magnitude Fourier transform domain. In one embodiment of the present invention, the position information may be encoded in one or more portions of an image by varying a characteristic of one or more elements of the image in accordance with the position and reference modulation patterns. An element may be image pixels, and the coded pattern is represented by variations to the intensities of the pixels. The coded pattern may be reproduced as a grayscale texture or combined with a non-coded image by adding a graininess to the image. To decode the coded pattern the system performs a two-dimensional fast Fourier transform and identifies the spatial frequencies and relative angular orientations associated with the respective modulation patterns. The system then determines relative position by triangulation.

### CROSS-REFERENCE TO RELATED APPLICATIONS

The present application claims the benefit of U.S. Provisional Patent Application Serial No. 60/371,077, which was filed on Apr. 9, 2002, entitled ANGULAR SYMBOLOGY WITH POSITIONING and is related to U.S. patent application Ser. No. 09/921,172, which was filed on Aug. 2, 2001, entitled DATA ENCODING AND DECODING USING ANGULAR SYMBOLOGY, each of which is hereby incorporated by reference.

### BACKGROUND OF THE INVENTION

1. Field of the Invention

The invention relates generally to data encoding and decoding and, more particularly, to encoding data onto, and decoding data from, an underlying substrate, such as a non-coded image.

2. Background Information

There are numerous applications in which machine readable data must be encoded on a paper document or other substrate. Typically such data is encoded using a printable symbology, either as a form of barcode, or as characters optimized for Optical Character Recognition, i.e., in an “OCR type font.” There are numerous applications of machine readable printed symbologies, for example: product identification—notably the ubiquitous Universal Product Code symbol, document identification, postal mailpiece identification and sorting, and so on. Even postage itself may be represented by a machine readable printed symbology, as for example in the United States Postal Service's Information Based Indicia Program.

A barcode specifies data symbols as an arrangement of lines that vary in relative size and spacing. In one dimensional (1-D) barcodes the lines vary by width and relative horizontal spacing. In two dimensional (2-D) barcodes, the lines vary also by relative vertical length or relative position. As is common, the barcodes may be overlaid on an otherwise blank portion of, for example, a price tag.

The three main advantages of barcodes are that they are printable using a simple “black and white” printing process, are machine readable using a scanner, and are easily decoded. However, current barcodes suffer from a number of limitations. Specifically, ID barcodes do not encode enough data per square inch of paper for many applications. Two dimensional barcodes encode more data, but are visually obtrusive. Typically, a barcode must have its own reserved area including a white or uniform background for the barcode itself, as well as a white or uniform border (known as a “quiet zone”) that is actually larger than the barcode itself. We refer to the reserved area and the quiet zone together as the “barcode region.” Other visual content must be eliminated from the barcode region, which in most practical applications limits the realizable data carrying capacity since the space, or “real estate,” that may be devoted solely to the machine readable symbol is limited.

Barcodes may also be too visually intrusive to be combined with certain media, such as, for example, photographic images. A combination of the barcode region and the underlying image essentially obliterates the portions of the image in which the barcode is included. Accordingly, the use of the barcode may not be acceptable. Further, the relative spacings, widths and other characteristics of the barcode may be altered if the combined image is scaled or compressed for transmission, or if the combined image is tilted or rotated as it is scanned for transmission. In addition, the barcode may be defaced before, during or after transmission. The encoded data in the received image cannot then be accurately decoded by the recipient.

Further, another of the reasons that barcodes and other prior printed symbologies cannot be successfully combined with images is that they typically encode the data in a spatially localized form, which means that if any portion of the symbol is destroyed, not viewable by the scanner, and/or obfuscated by an image, a portion or all of the data may be lost. The localized representation of the data thus limits the robustness of the encoding.

A final limitation of most symbologies known in the art is their stringent registration requirements. The coded pattern must be correctly oriented, positioned and sized relative to a viewing window of the scanner in order to be properly read and decoded. If only a portion of the barcode passes by the viewing window or the code is incorrectly registered, the scanner may misinterpret the data included in the coded pattern, without notifying the user of the mistake. It is necessary for the reading device effectively to view and identify the edges (left and right for a ID barcode, left, right, top, and bottom for a 2D barcode) of the bar code region before any of the data can be recovered. If the edges of the barcode region are obfuscated, out of view, or destroyed, the scanner may not be able to decode any of the data. Further, this may occur even though only a small edge portion of the coded pattern and/or the surrounding quiet zone has been destroyed or is not viewable by the scanner.

In addition, with the stringent registration requirements, barcodes and other prior printed symbologies are not particularly well suited for use in fully automated reading system. In systems such as a market checkout, for example, a user is present to properly position and orient the coded pattern, that is, the barcode, relative to the viewing window. Thus, it is commonplace for a user to move an object further from or closer to the window, and/or reorient the product relative to the window until the check-out scanner correctly decodes the price, product type and so forth. In a fully automated system, however, registration of the barcodes relative to the scanner window may be a problem if the underlying media tilts, rotates or shifts relative to the scanned window. Accordingly, the barcodes may not be successfully read.

We have developed an “angular symbology” technology that addresses these problems. The angular symbology technology is discussed in U.S. patent application Ser. No. 09/921,172 entitled DATA ENCODING AND DECODING USING ANGULAR SYMBOLOGY filed Aug. 2, 2001 which is incorporated herein in its entirety by reference. The angular symbology technology is also discussed below in Section 1 of the application.

The angular symbology technology solves the problems discussed above by providing a symbology that is both rotation and translation independent and robust to destruction or obfuscation, yet is visually satisfying as a stand-alone pattern or as part of a coded image. The code pattern resembles a texture, and when combined with a non-code image adds a “graininess” to the underlying image. The code pattern or a coded image is printable in a simple “black and white” printing process, as well as in color or grayscale printing processes and/or other machine-readable and/or visible forms.

The current system further encodes into the code pattern or coded image information from which the relative position of a reader may be determined. The system may then use the position of the reader to access related information that is contained in associated image or data files, such as, for example, an explanation of something depicted in the image. Further, the system may use the position-related information to direct the reader over designated portions of the image for the purposes of decoding and/or acquiring additional information from the image or the underlying substrate, such as, for example, information that is used for authentication.

### SUMMARY OF THE INVENTION

The invention is an encoding system that includes position information in a code pattern or a coded image by varying an image characteristic in accordance with modulation patterns that are radially symmetric about respective predetermined locations, or center points. The system may also include data in the image by further varying the image characteristic in accordance with modulation patterns that have relative angular orientations and frequencies that correspond to the data. The modulation patterns for the position-related information and data may be, for example, radial and linear sinusoidal patterns, respectively, and the image characteristic that is varied in accordance with the sinusoidal patterns may be, for example, pixel intensity.

Briefly, an elementary component is a modulation pattern that may be imposed on an underlying substrate at a defined orientation relative to a reference and which has a 2-D Fourier transform that is characterized by components that are sufficiently localized. These localized components can then be recovered without excessive computation. A reference component is included such that the relative angular orientations can be determined for data decoding.

While in the preferred embodiment discussed herein the elementary component is a sinusoidal linear pattern that has a pair of impulse functions as its Fourier transform, the elementary component may be any other pattern that has a Fourier transform with sufficiently localized components.

A beacon is a modulation pattern that is radially symmetric about a center point with a known location. The beacon has a 2-D Fourier transform that is characterized by a circle about its center point at a radius that corresponds to the associated frequency. The energy of the beacon is distributed evenly over the circle if the center points of the viewable section and the beacon coincide. Otherwise, the energy is distributed in such as manner as to indicate the orientation of a line through the center point of the beacon and the center point of the viewable, that is, to indicate the angular offset between the two center points. As discussed in more detail below, the system determines the relative location of center of the viewable section by triangulation when two or more beacons are encoded in the image.

While in the preferred embodiment discussed herein the beacon is a sinusoidal radial pattern that has a radially symmetrical function as its Fourier transform, the beacon may be any other pattern that has radially symmetrical components. For ease of decoding, the beacons may have the same frequency. The selected beacon frequency must, however, differ from the various frequencies used for data encoding.

To encode the data, which consists of a string of symbols, the system first specifies a reference elemental component by selecting a reference orientation and a reference frequency. The reference frequency is preferably selected to be the highest spatial frequency in a group or band of frequencies used for data encoding. The system next associates one or more symbols with each of the remaining spatial frequencies in the band by, for example, assigning a first set of symbols to the highest of the remaining set of frequencies, a second set of symbols to the next highest of the frequencies, and so forth. The system then assigns angular orientations to the respective symbols based on the numerical values of the symbols, where the “values” correspond to the underlying bits that are to be encoded in the components.

To include both the data and the beacons in the image, the system determines how pixel intensities are to be varied by a combination of the reference and data elemental components and the corresponding components of the respective beacons. Typically, this is done by printing the pattern on the substrate. The system may instead encode the position information, without the data, by determining how the pixel intensities to be varied by a combination of the reference elemental component and the components of the various beacons.

The result is a coded pattern that is essentially a texture or what is sometimes referred to herein as a “coded texture.” As discussed, the coded pattern may be combined with one or more non-coded images by adding a graininess to the underlying images or the coded pattern may be used alone, and thus, printed as a texture.

The system first recovers the reference orientation and then recovers the position-related information, such that the angles associated with the lines between the respective beacon center points and the center point of the section of interest are determined relative to a reference axis defined by the reference orientation. If the coded pattern includes data, the system also recovers the data symbols, and thus, ensures that the reference orientation has been correctly decoded, as discusssed in more detail below. For decoding, the system performs a 2-D fast Fourier transform (FFT) of the coded pattern, to recover the spatial frequencies and orientations associated with the reference and/or data components. Assuming data is included, the resultant transform defines a set of “reference points,” various sets of “data points” and “position points,” each of which are characterized by a frequency and an angular orientation corresponding to that of the associated visual modulation patterns that were impressed on the substrate. The system determines the reference orientation by determining the points of maximum energy at the reference spatial frequency associated with the data. These points, which are the reference points, define the reference axis from which the angular orientations of the respective sets of data points are determined. The system then decodes the angular information into the corresponding symbols, and arranges the symbols to reproduce the data.

The system recovers the position information from the 2-D FFT in a similar manner. The system essentially recovers the position information, by determining the points of maximum energy at the beacon frequency or frequencies. For a given beacon, the associated position points are on a line drawn through the center point of the beacon and the center point of the section of interest, where the section corresponds to what is viewed by a reader at a given time, i.e., a “viewable.” Accordingly, the system determines the relative position of the reader by calculating the angles between the known locations of the center points of the beacons and the center point of the viewable. As discussed in more detail hereinafter, the center point of the viewable is the center of the reference axis, which is determined using the angular symbology.

The position information contained in the coded pattern can thus be used to determine what portion of the image is of current interest to a user, that is, what the user is currently examining through the reader. The position coordinates can then be used to enter files, tables or databases that contain data, images, and so forth, in order to present to the user information that relates to what is depicted in that portion of the image. For example, the user may position the reader over an area of a map and be provided with information such as more detailed images of a particular city or data relating to population, and so forth, of the city.

The position information contained in the coded pattern can also be used to determine when the reader is in a desired location in the image, such that other information can then be obtained from the image or the underlying substrate. For example, using the position information, the system determines when the reader is in the location in the image that is associated with FiberFingerprint data. (FiberFingerprint™ is a trademark of The Escher Group Inc., the Assignee of the current application). The system then reads from the underlying substrate or an inhomogeneous medium applied to or embedded in the substrate authentication information that corresponds to the surface geometries of the substrate and/or the inhomogeneous medium. The authentication techniques are discussed in U.S. patent application Ser. No. 09/719,430 filed Dec. 12, 2000 entitled WORKPIECE AUTHENTICATION BASED UPON ONE OR MORE WORKPIECE IMAGES and U.S. patent application Ser. No. 10/236,697 filed Sep. 6, 2002 entitled SYSTEM AND METHOD FOR AUTHENTICATION AND TRACKING OF A WORKPIECE THAT INCLUDES AN OPTICALLY ACTIVE MEDIUM, which are incorporated herein in their entirety by reference. The use of the beacons in conjunction with the authentication techniques and technology is discussed in more detail below in Sections 4 and 5.

The data and the position information can be readily decoded from a coded pattern or a coded image by machine, without user intervention. Misregistration of the coded pattern relative to a scanning window or viewable in terms of orientation, translation or rotation, does not adversely affect the data decoding operations or the position information decoding operations, which rely on a reference orientation that is encoded into the code pattern or coded image.

### BRIEF DESCRIPTION OF THE DRAWINGS

The invention description below refers to the accompanying drawings, of which:

FIG. 1 is a photograph of a simplified coded texture containing data symbols;

FIG. 2 depicts pictorially the results of a 2-D FFT of a coded texture containing data symbols;

FIG. 3 is a functional block diagram of an encoding system that produces the coded textures of FIGS. 1 and 2;

FIG. 4 is a functional block diagram of a decoding system that decodes the coded textures;

FIGS. 5A-B are photographs that depict a non-coded image and a coded image, respectively.

FIG. 6 depicts an image that contains a beacon and certain results of a 2-D FFT of the image;

FIG. 7 depicts pictorially a reference axis and lines associated with various position beacons;

FIG. 8 is a functional block diagram of an encoding system that produces coded textures which include one or more beacons;

FIG. 9 is a functional block diagram of a decoding system that decodes the coded textures which include one or more beacons.

### DETAILED DESCRIPTION OF AN ILLUSTRATIVE EMBODIMENT

The position information is typically included in a coded pattern that also includes data, such that the system can accurately determine the correct reference orientation or axis. If the code pattern is to be used as a texture, the code pattern may include only the reference component, since there is no underlying image spatial information that essentially competes with the coded pattern. The reference and position information in the texture can thus be readily determined by the local maxims at the desired frequencies. Data may however be included in the texture to ensure the accuracy of the decoding.

We discuss the data encoding in Section 1, and then in Section 2 the inclusion of the position information in the coded pattern.

Section 1—Encoding Data with Angular Symbology

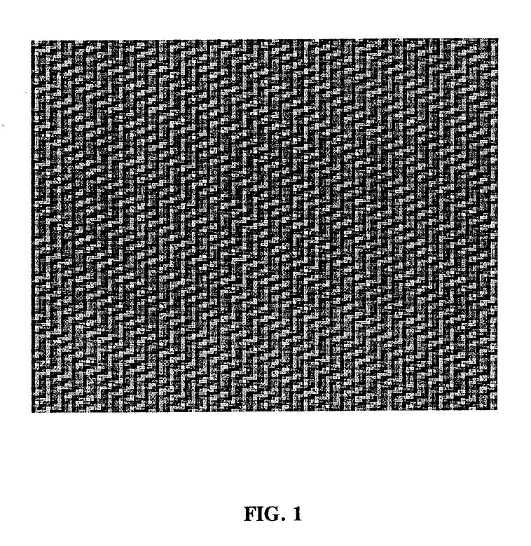

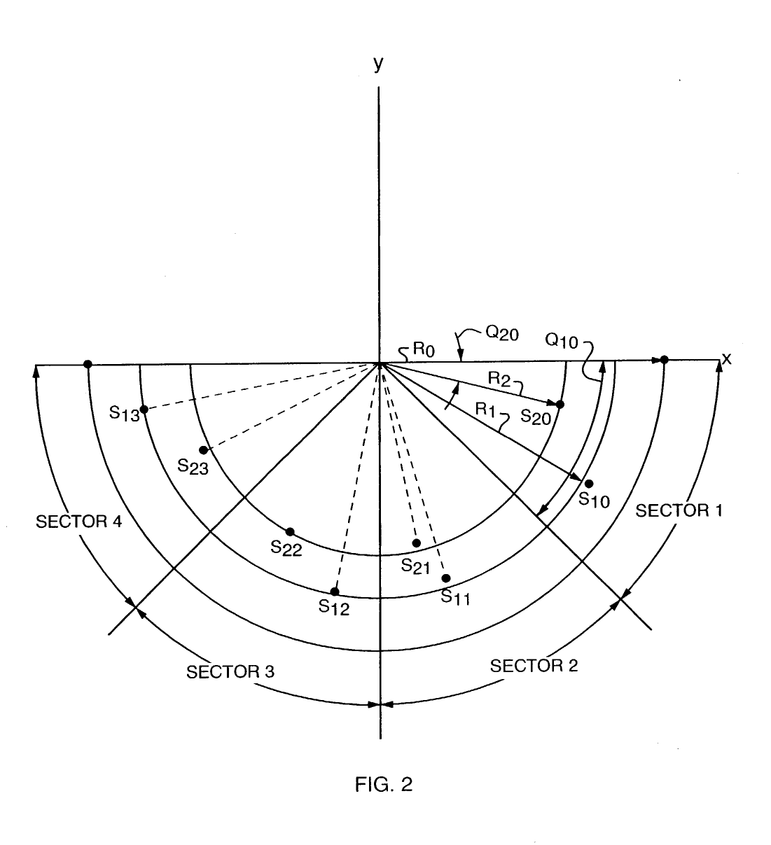

Referring now to FIGS. 1 and 2, an illustrative coded pattern 10 includes contributions from a set of elementary components, comprising a reference component and one or more data components. The contributions correspond to variations in pixel intensities that form a visual texture. For simplicity, we have included two data components in the coded pattern. It will be understood that typically more data components are included.

An elementary component is associated with a spatial frequency and an angular orientation. In the example, the elementary component is a sinusoidal linear pattern. The sinusoidal linear pattern is selected because this pattern is represented in the magnitude Fourier domain as a symmetrically positioned pair of non-zero points v_{i,0} v_{i,1} that occur on a circle of radius Rᵢ, where Rᵢ corresponds to the associated spatial frequency. Further, the points are at an angle θ from a reference direction that corresponds to the angle of the spatial component with respect to a reference component.

By selecting a particular spatial frequency R₀ and angular orientation θ₀ as a reference, the system can define x and y axes on a Fourier plane based on the positions of the associated points v_{0,0} and v_{0,1} on the circle of radius R₀. Specifically, the system positions the x axis through the points and the y axis half-way between the points, such that the origin is at the center of the circle of radius R₀. The sets of data points that correspond to the remaining elementary components then have distances from the origin that correspond to the spatial frequencies and angular orientations of the coded pattern which defines the underlying data. Since each pair of data points is symmetric about the origin, only one of each pair is actually needed for the decoding. As a matter of choice, we used the data set comprising data points in the lower-half plane, and measure angles clockwise from the x reference axis.

FIG. 2 is a representative illustration of the magnitude Fourier domain transform of a set of sinusoidal spatial patterns, each designed by a pattern repetition frequency and a spatial pattern orientation relative to a referenced pattern. The radii Rᵢ, or the associated spacial frequencies, may be considered as information “carriers,” and will be referred to as such hereinafter. The magnitude of a given carrier (i.e., radial distance from the origin) corresponds to the spatial frequency of its associated elementary components. One of these carriers, referred to as the “reference carrier,” supports a single elementary component that conveys a reference orientation for the symbology. The remaining carriers, referred to as the “data carriers,” may each support a plurality of elementary components and are used to convey the data payload.

In accordance with the present invention, the data payload, which is a string of data or bits including both user data and error detection and correction information, is grouped into sets of symbols, Sᵢ, with each symbol comprising b bits. Each data carrier is assigned one or more symbols in the sequence, with each symbol being assigned a different angular orientation. Each one of the symbols will thus be conveyed by a different elementary component. In the preferred embodiment herein, we assign four symbols to each data carrier, with each symbol carrying four bits, and use seven data carriers so that a total payload of 112 bits can be carried by the coded texture.

This is illustrated in FIG. 2, which shows a reference carrier that defines the reference x axis, and data carriers R₁ and R₂, respectively. Each symbol S_{i,j} corresponding to a data carrier Rᵢ is assigned to a separate one of the four sectors, each sector occupying π/4 radians. This facilitates decoding since the angular orientation associated with a given symbol is measured in each sector. In the drawing carrier 1 is associated with symbols S_{1,0}, S_{1,1}, S_{1,2} and S_{1,3}, each located on or near the carrier radius R₁ but in a different one of the sectors, and similarly for carrier 2, etc.

The data capacity of the angular symbology depends on the accuracy with which angular orientation can be measured. Transmitting, copying or printing of the coded pattern as well as interference between the pattern and features of an underlying image may adversely affect the measurements. Accordingly, a system designer must determine the number of carrier frequencies based on the resolution with which the frequencies can be detected, and the number of data symbols per carrier and also the number of bits per symbol that can be reliably decoded from the coded pattern based on the resolution with which angular measurements can be made at the various frequencies. Higher frequency carriers are generally easier to detect and accurately measured. Thus, they may be used to convey more data symbols and/or larger data symbols then lower frequency carriers.

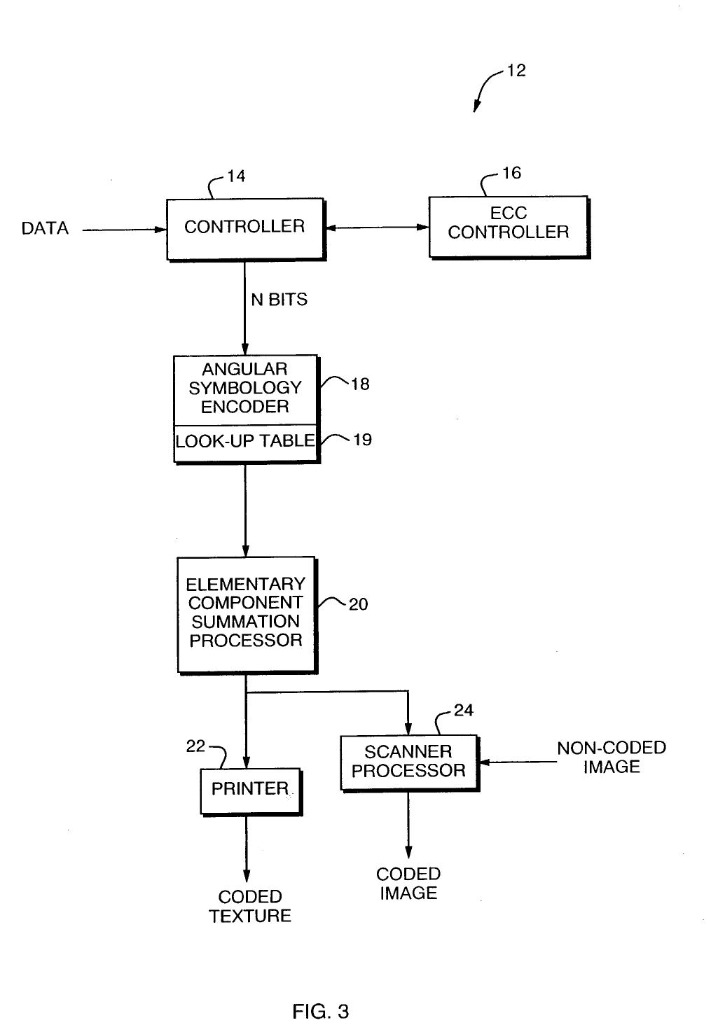

Referring now to FIG. 3, an encoding system 12 includes a controller 14 that receives data which is to be encoded to provide a coded pattern. The controller 14 controls an error correction encoder 16 that, in a conventional manner, encodes the data as a string of data symbols and produces corresponding error correction code detection and correction information such as parity bits or redundancy symbols, which are referred to collectively herein as “ECC symbols.” The controller 14 then concatenates the data and the ECC symbols into a payload of N bits.

An angular symbology encoder 18 parses the N bits into data symbols of, for example, 4 bits each. The encoder then associates the data symbols with selected spatial frequencies, or data carriers, based on the positions of the symbols in the N-bit payload. The system assigns the first d symbols to a first data carrier, the second d symbols to a second data carrier and so forth. Next, the system assigns an angular orientation to a given symbol based on the symbol numerical value. The encoding system of FIG. 1 uses a lookup table 19 to assign an angular orientation to an data symbol, entering the table with the symbol. Alternatively, the angular symbology encoder 18 may calculate the angular orientation for the data symbol, as discussed below.

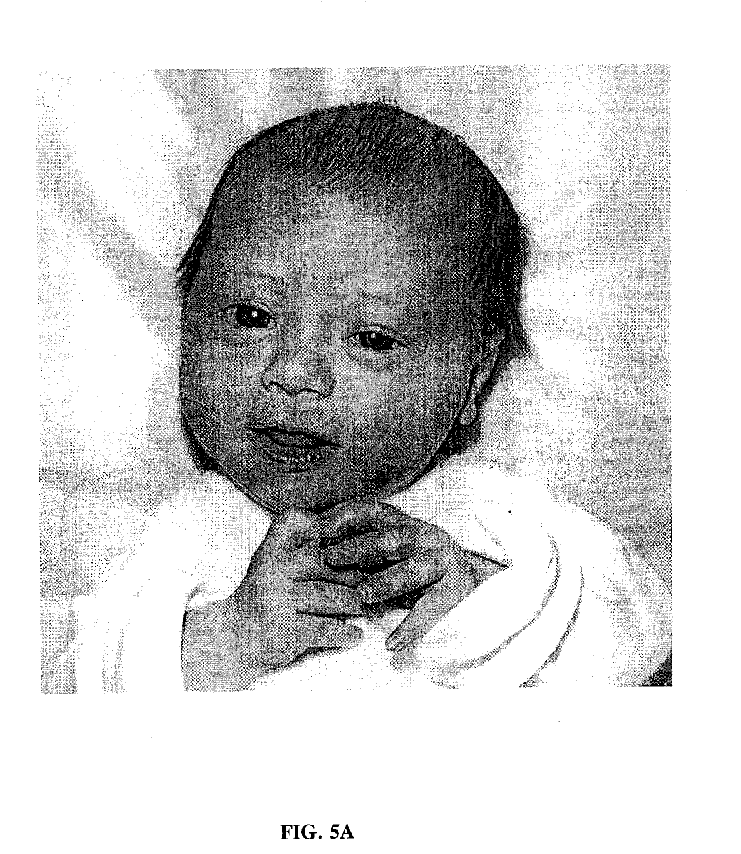

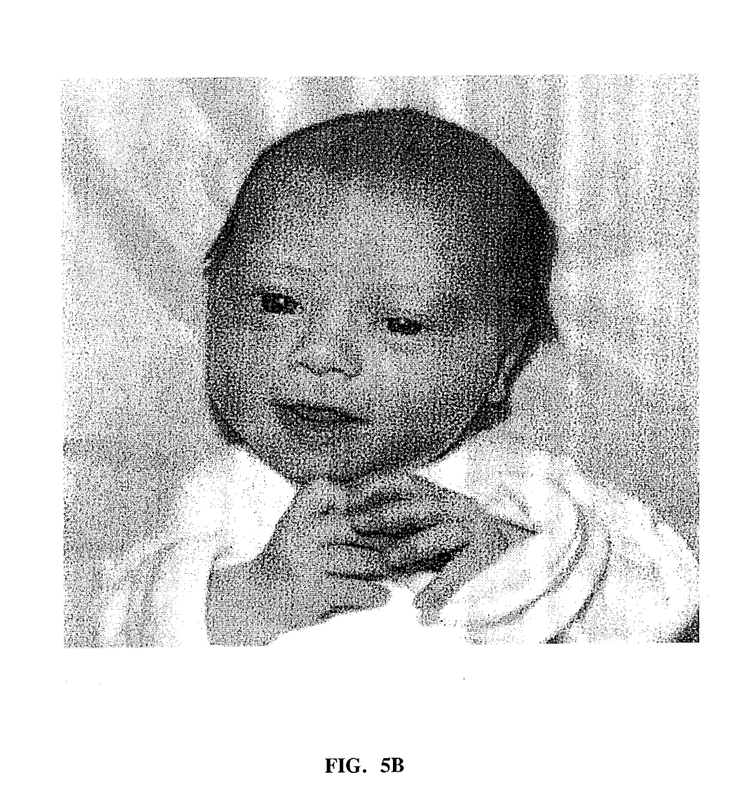

An elementary component summation processor 20 uses the reference and data carrier and angular orientation information to produce a pattern of associated sinusoids by calculating the contributions of the sinusoids to pixel intensities. In the example, the pixels intensities are represented as gray scale values, and the coded pattern is reproduced by a printer 22 as a black and white texture as depicted in FIG. 1. The texture can then be used in the same manner as a 2-D barcode. Alternatively, the coded pattern may be combined with a pre-existing image (FIG. 5A) in a scanner processor 24, to produce a combined image that includes the data as an added texture or graininess, as depicted in FIG. 5B.

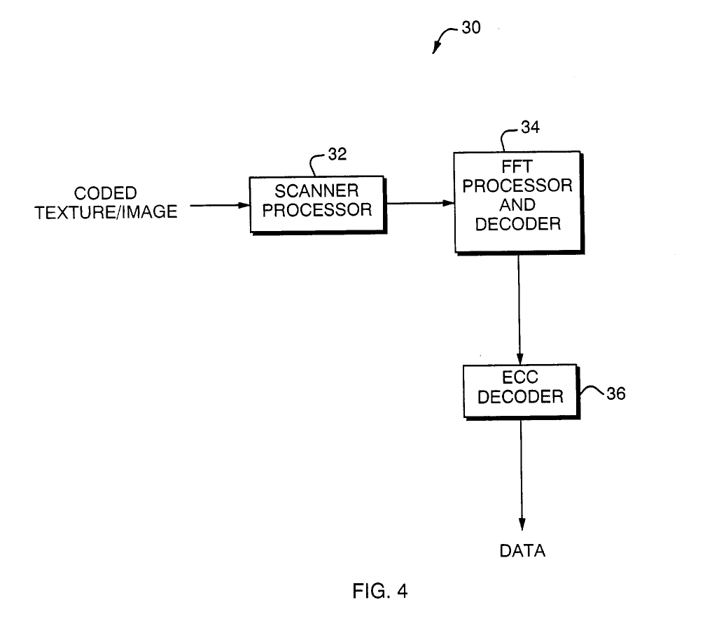

Referring now to FIG. 4, a decoding system 30 includes a scanner processor 32 that scans the encoded image and reproduces the pixel values as gray scale values. An FFT processor and decoder 34 next performs a 2-D FFT in the magnitude domain using the pixel values. Before performing the FFT, the processor may smooth the gray scale values by applying a 2-D Hamming window, in order to reduce boundary condition effects from the results of the FFT.

The FFT processor 34 produces one or more pairs of data points for each sinusoid that is included in the pattern. The data points for a given sinusoid are located on a circle of radius Rᵢ, where Rᵢ corresponds to the associated spatial frequency. The decoder then determines the reference orientation by identifying the maximum points that lie on or sufficiently close to a circle of radius R₀, where R₀ is the spatial frequency of the reference carrier. In the example, R₀ is the highest spatial frequency in the group of frequencies used to encode the data.

The decoder further determines the angles between the reference orientation and the data points associated with the remaining carriers or, as appropriate, the angles relative to sector boundaries, which are defined relative to the reference orientation. The decoder then enters a look-up table 39 to reproduce the associated data symbols. Alternatively, the decoder manipulates the angular information to reproduce the data symbols and arranges the symbols in an appropriate order to reproduce the N-bit payload. The decoder provides the N-bit string to an error correction decoder 36, which decodes the string as data and ECC symbols and, as appropriate, detects and/or corrects errors therein. The decoder will likely have to interpolate the angular orientation values it derives from the FFT. The system thus associates the derived, or measured, values with the spatially closest valid frequency and angular orientation values, without crossing associated sector boundaries. As discussed, if valid data is not produced, the system linearly scales the reference and data carrier frequency values and again decodes the results, until valid data is retrieved.

The system designer selects the data carriers such that they are sufficiently spaced to enable reliable and rapid decoding using the Fourier domain of interest. With images that have expected resolutions of at least 300 dpi over a viewing, or recovery, region of the 0.25 square inches, good selections are

W₀≈660 rad.inch⁻¹=26,000 rad.m⁻¹

for the reference carrier and

Wₖ≈60(10−k)rad.inch⁻¹=2363(10−k)rad.m⁻¹

for the respective k data carriers.

The Fourier plane is segmented into 2d sectors for a data carrier that conveys d data symbols. If the symbols include b-bits, a given symbol is encoded into one of 2^{b} angular segments of a sector, since there are 2^{b} possible b-bit symbols represented by a given sector. Based on the value of a given symbol, the i^{th} b-bit data symbol associated with the k^{th} data carrier has a symbol value of S_{k,i}, and the angular orientation associated with the data symbol is

$${Θ}_{k , i} = {Θ}_{0} + π [ \frac{1}{40} + \frac{i}{{d}_{k}} + ( \frac{1}{20} + \frac{1}{{d}_{k}} ) \frac{{S}_{k , i}}{{2}^{{b}_{k}}} ]$$

where θ₀ is the reference angular orientation, dₖ is the number of symbols per carrier k and bₖ is the number of bits per symbol associated with carrier k. In the example, the data symbols are treated as Gray code symbols and assigned numerical values accordingly, to ensure that relatively slight errors in angular measurement translate to symbol values that can be readily corrected to the recorded symbol value.

In the example, the angular orientations θ_{k,i} do not span the entire associated sectors. Using the formula above, a boundary of π/20 radians is taken out of each sector. Thus, data symbols encoded on to the same data carrier will be spaced at least π/20 radians apart, and the estimates of local maxima that represent the symbols in the magnitude Fourier domain should not interference with one another.

To produce the coded pattern, the system determines how the sinusoids that correspond to the assigned spatial frequencies and angular orientations modify pixel intensity values. With the system using linear sinusoidal patterns as the elementary components, the contribution of the sinusoids at a given pixel at location (x, y) is:

$$c ( x , y ) = cos ( {w}_{R} ( x cos {Θ}_{0} + y sin {Θ}_{0} ) + ϕ ) + {\sum }_{k = 1}^{n} {\sum }_{i = 1}^{d} cos ( x cos {Θ}_{k , i} + y sin {Θ}_{k , i} ) + {ϕ}_{k , i} )$$

where φ₀ and φ_{k,i} are assigned phases that ensure that the contributions of the respective symbols in each sector do not overlap in a manner that adversely affects decoding.

The coded pattern is a gray scale texture that is composed of fairly high spatial frequency components. If an image with which the coded pattern is to be combined contains strong frequency components in the coding band of interest, combining the image and the pattern may adversely affect decoding. Accordingly, before combining the coded pattern and the non-code image, the system preferably linearly filters the image using an empirically defined finite impulse response two-dimensional low pass filter, to essentially remove from the underlying image those spatial frequency components that are in use for encoding. To speed the computations involved in the filtering, the system may use a sliding two-dimensional correlation window or matrix M, selected such that

M=UU^{T}

where U is a vector of length L.

The sliding of the matrix over the image can be expressed as the cascade of two one dimensional filtering stages over the two dimensions of the image. The elements of U represent the impulse response of the one-dimensional filtering stages. The two-dimensional filtering can thus be performed as 2L multiplications, as opposed to the L² multiplications that may be required with other 2-D filtering schemes. The dimensions of the matrix M may be made relatively small, to minimize the visual impact of the filtering.

The system may adjust the intensities or associated gains of the pixels in the combined image to ensure that pixel values remain below the maximum pixel intensity values of a printing device. Further, the system may use adaptive gain control techniques to improve the visual appeal of the combined image by, for example, mixing less of the gray scale texture with the white or brightest portions of the underlying image. The texture then does not overwhelm these portions.

The system may imbed different data in different portions of an underlying image or identical sets of data in various portions of the image. The system thus applies various coded patterns to the different portions of the image, or produces “coded tiles” that together represent the overall coded pattern that is combined with the underlying image. To smooth the transitions between the coded tiles, the system overlaps fade-in/fade-out portions of the tiles, leaving the centers of the tiles intact for decoding.

For tiles that carry different data, the overall coded pattern can be formulated as a weighted average of the tile textures, with the weighting associated with a given tile decreasing with the distance from the tile center. The weights may, for example, vary exponentially with distance.

Section 2—Position Information

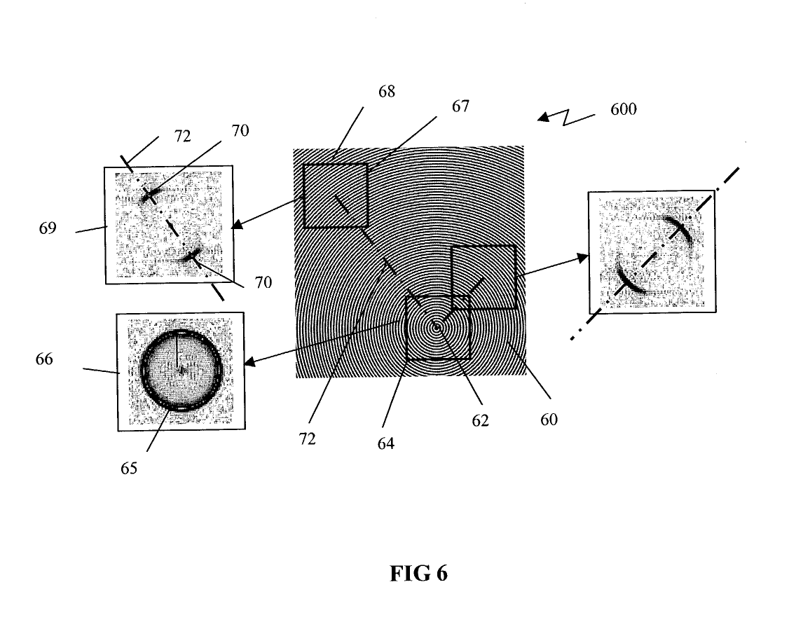

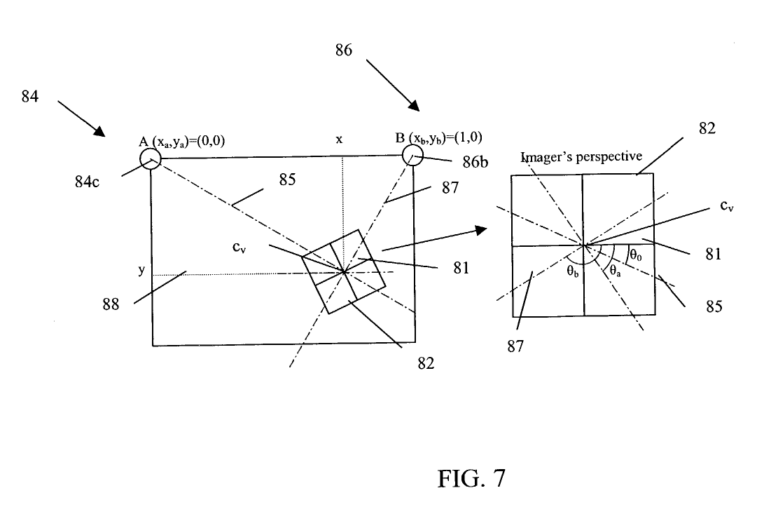

Referring now to FIG. 6, a beacon is depicted in an image 600 as a radially symmetric modulation pattern 60 with a center point 62. As illustrated in the drawing, the FFT magnitude plot 66 of an image sub-section 64, which is centered on the beacon, is a circle 65 with radius R, where R corresponds to the spatial frequency of the pattern 60. For a given sub-section 68 that has a center point 67 that is not coincidental is the center point 62 of the beacon, the FFT magnitude plot 69 includes points 70 of maximum magnitude where the circle of radius R intersects a line 72 that is drawn through the respective centers of the beacon and the subsection 62 and 67. As discussed in more detail with reference to FIG. 7, the system calculates the relative position of the reader based at least in part on the line 72 between the center points and the reference axis associated with the subsection 68, as determined using the angular symbology.

Referring now to FIG. 7, we discuss the use of the beacons to determine the relative position of a sub-section 82 of an image 80 that is a viewable associated with a reader (not shown). Two beacons 84 and 86 are included in a coded pattern that is applied to the image. In the example, the beacons are centered at the top corners of the image, and the width of the image then acts as a reference scale for the center position of the image.

The system uses the angular symbology to determine for the viewable a reference orientation θ₀, that is, a horizontal axis 81, that has a known orientation with respect to a horizontal axis 88 of the image 80. The system next recovers the directions of the beacons 84 and 86 relative to the reference axis, by determining local maxima at a radius that corresponds to the frequency or frequencies of the beacons. The local maxima are points on lines 85 and 87 through a center point cᵥ of the viewable and the center points 84c and 86c of the respective beacons. The system then determines the angle θₐ between the reference axis 81 and the line 85 associated with the beacon 84, and the angle θ_{b} between the reference axis 81 and the line 87 associated with the beacon 86. Finally, the system determines the relative position of the center cᵥ of the viewable within the image as:

$$x = \frac{tan ( {θ}_{b} - {θ}_{0} )}{tan ( {θ}_{b} - {θ}_{0} ) - tan ( {θ}_{a} - {θ}_{0} )} and y = \frac{tan ( {θ}_{a} - {θ}_{0} ) tan ( {θ}_{b} - {θ}_{0} )}{tan ( {θ}_{b} - {θ}_{0} ) - tan ( {θ}_{a} - {θ}_{0} )}$$

Section 3—Encoding Position Information into a Coded Pattern

As discussed above, the beacons are radially symmetrical modulation patterns. We use radially symmetrical sinusoidal patterns in the example discussed below.

The system includes the beacons in a coded pattern as

$$B ( x , y ) = {\sum }_{k = 0}^{nbeacons - 1} cos ( {ω}_{b , k} \sqrt{{( x - {X}_{b , k} )}^{2} + {( y - {Y}_{b , k} )}^{2}} )$$

where the beacons are centered at the locations (X_{b,k}, Y_{b,k}) in the image and the beacon spatial frequencies are ω_{b,k}.

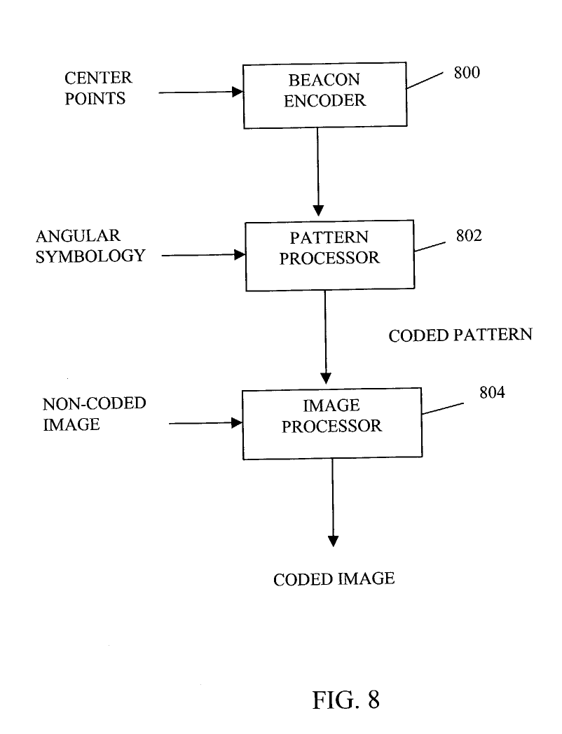

Referring now to FIG. 8, a beacon encoder 800 determines how the intensity of each pixel is affected by the inclusion of the beacons with selected center points. The beacon encoder thus essentially produces a texture that corresponds to the radially symmetric functions. A pattern processor 802 then includes the beacons in the coded pattern by adding therein the texture produced by the beacon encoder. Accordingly, the pattern processor determines how the angular symbology encoding and the beacons together affect the pixel intensities, to produce a coded pattern. As appropriate, an image processor 804 modifies the pixels in a non-coded image to include the coded pattern therein as a graininess or texture.

The coded pattern of data and position information may also be used alone as a coded pattern or texture that is applied to a substrate in a manner similar to that of a bar code, as discussed above.

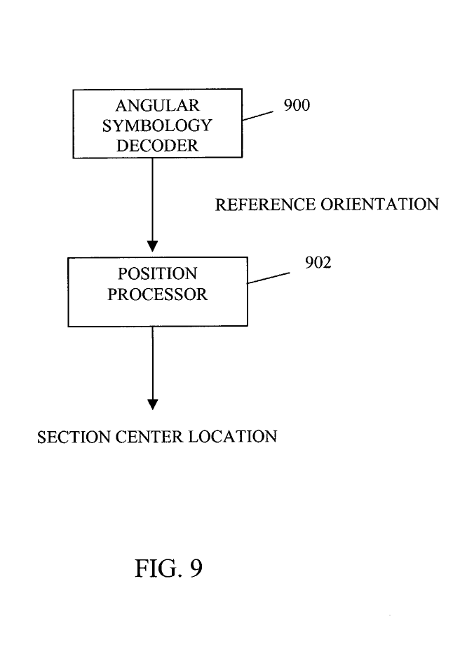

Referring now to FIG. 9, the system decodes the position information from, for example, a coded image, by first operating in the manner discussed above with reference to FIG. 2. Thus, an angular symbology decoder 900 determines at least the reference orientation, using the angular symbology. A position processor 902 then determines the local maxima at the radii that correspond to the spatial frequencies associated with the beacons. In the example, the beacons have the same spatial frequency, which differs from the data and reference frequencies. The beacons may, for example, have a frequency that is well above the frequency range associated with the data.

As discussed above, the local maxima at the beacon frequency are on lines that intersect the associated beacon center points and the center point of the reference axis of the viewable, that is, the center point of the viewable. The position processor thus determines the angles between the various lines and the reference axis, and then calculates the relative position of the center point of the viewable by triangulation. The relative orientation of the reader is also known modulo 180°, based on the orientation of the reference axis.

Section 4—Using Position Information to Register a Reader

The system may use the position information to register a reader in order to enter related data or image files, tables, databases, and so forth (not shown). For example, the underlying image may be a map and the user may place a reader on a particular location on the map, to request more information about the city or attraction depicted in the map. More generally, the reader may be used as a position input device, such as a mouse.

The position information may also be used for navigation. For example, positions beacons may be printed on a wide scale, such as on a floor, and a robot may use the information to move in a desired direction or to a designated area. The position information may also be used for measurements, distances and so forth, to determine for example how far a robot or other device has moved, the relative dimensions of objects, the distances between locations on a map, and so forth.

Section 5—Using Position Information in Conjunction with Authentication

The system may use the position information to determine when the reader is over a designated area in the underlying substrate. The system may then obtain “authentication information” from the substrate or an inhomogeneous medium applied to or embedded in the substrate. The authentication information corresponds to various degrees of freedom associated with the surface geometry of the substrate or with “optically active components” of the inhomogeneous medium. The authentication information is acquired when the reader illuminates the designated area and then reads associated patterns of reflected, diffracted and/or emitted light. The term “optically active components” refers to components of the inhomogeneous medium that have irregular surfaces or shapes and/or essentially random relative positions, orientations and so forth. The optically active components may be, for example, reflective flakes included in an optically variable ink or paint, reflective and/or fluorescent gems included in gemstone dust, and so forth.

The system compares the authentication information, or values related thereto, with stored authentication information or values information or values that have been encoded into or written onto the substrate, to determine authenticity. The authentication information or values may, for example, be encoded using the angular symbology.

The substrate may be the paper on which a document, a postal franking mark or currency information is printed or the substrate may be an object, such as a credit card. As an example, a credit card may have gemstone dust included on or embedded in all or a portion of the card. The coded pattern that contains the position information may then be engraved into the credit card itself using, for example, a laser. Alternatively, the coded pattern may be engraved or otherwise embedded in a cover layer that is laminated on to the card, and so forth.

While we have discussed the encoding operations and the authentication operations in terms of a printed document, a credit card and so forth. The system may, however, be used with other media.

We have depicted that system as including a plurality of processors, such as the beacon encoder and the angle symbology encoder. The processors may be combined into a single processor or arranged as various other grouping of processors. The instructions for the operations that the processors perform may be stored on memory resident on the respective processors, or on memory that is resident on certain of the processors and shared with or made available to other processors. Alternatively, the instructions for one or more of the operations may be made available to or communicated to the processors by, for example, the controller. Further, the system may store, or transmit, print or otherwise provide the coded pattern and/or a coded image to a user. Similarly, a coded pattern or the coded image may be transmitted to or provided in hardcopy to be scanned into the system for decoding.

The system is readily implemented by means of one or more digital processors, either general purpose or special purpose. Conventional signal processing software and algorithms are readily applied to perform the requisite processing described herein.

What is claimed is:

1. Method for use in encoding position-related information in at least one portion of an image, the at least one portion including a plurality of image elements, the method comprising:
determining a reference modulation pattern to be applied to a characteristic of the elements, the reference modulation pattern having a reference angular orientation and a reference frequency;
determining at least two position modulation patterns having the same or different frequencies, the position modulation patterns being radially symmetrical about respective center points; and
modifying the characteristic of the image elements in accordance with a coded pattern that is a combination of the reference and position modulation patterns.

2. Method for use in decoding position information and reference orientation information encoded in at least one portion of an image, the at least one portion including a plurality of image elements, the method comprising:
determining in a coded pattern in the elements a reference modulation pattern that is associated with a reference angular orientation and a reference frequency and defines a reference axis;
determining in the coded pattern two or more position modulation patterns that are associated with one or more frequencies and are radially symmetric about respective position center points, the position modulation patterns having in the at least one portion respective angular orientations that correspond to offsets between the respective position center points and a center of the reference axis in the at least one portion; and
determining the relative position of the at least one portion based on the reference orientation and the angular orientations.

3. An image in which is encoded position-related information, the image including:
at least one portion including a plurality of image elements, and
a characteristic of the elements which is modulated to include a coded modulation pattern, the coded modulation pattern including contributions of
i. a reference elemental component having a reference angular orientation and a reference frequency and defining a reference axis in the at least one portion, and
ii. two or more position components having one or more frequencies, each position component also having an angular orientation that corresponds to an offset between a center of the reference axis and an associated position center point.

4. Method according to claim 1, wherein the characteristic is intensity values of the elements.

5. Method according to claim 2, wherein the characteristic is intensity values of the elements.

6. Image according to claim 3, wherein the characteristic is intensity values of the elements.

7. Method according to claim 1, wherein the reference modulation pattern is a sinusoidal linear pattern and the position modulation patterns are radially symmetrical sinusoidal patterns.

8. Method according to claim 2, wherein reference modulation pattern is a sinusoidal linear pattern and the position modulation patterns are a radially symmetrical sinusoidal patterns.

9. Image according to claim 3, wherein the reference component is a sinusoidal linear pattern and the position components are radially symmetrical sinusoidal patterns.

10. Method according to claim 1 further including the step of assigning different spatial frequencies to the reference and position modulation patterns.

11. Method according to claim 1, wherein one or more symbols that represent a data message and error correction redundancy information are encoded into the at least one portion of the image by determining for each given symbol a data modulation pattern having a frequency and an angular orientation relative to the reference orientation that corresponds to the given data symbol.

12. Method according to claim 2, further including
determining in the coded pattern one or more data modulation patterns having respective frequencies and respective angular orientations relative to the reference angular orientation,
associating respective symbol values with the angular orientations associated with the data modulation patterns,
arranging the symbols in accordance with the respective frequencies of the data modulation patterns to reproduce data and error correction information, and
determining after manipulation of the data and error correction information that the reference axis is correctly identified if the data are error-free.

13. Image according to claim 3, wherein the coded modulation pattern further includes data components having frequencies and an angular orientation relative to the reference orientation that correspond to respective data symbols, the data symbols representing a data message and error correction redundancy information.

14. Apparatus for use in encoding position beacons in at least one portion of an image, the at least one portion including a plurality of image elements, the apparatus including:
a position information encoder that associates one or more position beacons with respective position modulation patterns in the elements, the position modulation patterns being radially symmetrical about respective center points that have predetermined locations in the image;
an angular symbology encoder that associates a reference axis with a reference modulation pattern in the elements; and
a processor that encodes the plurality of elements by combining the position modulation patterns and the reference modulation pattern to determine a coded pattern that represents changes to a characteristic of the plurality of the elements to encode the position information in the plurality of the elements.

15. Apparatus of claim 14 wherein
the angular symbology encoder further associates one or more data symbols with respective data modulation patterns that are associated with angular orientations relative to the reference modulation pattern in the elements, the angular orientations being selected so as to have values that correspond to the respective one or more data symbols, and
the processor further encodes the plurality of elements by combining the data modulation patterns with the reference modulation pattern and the position modulation patterns.

16. Apparatus for use in decoding the position information encoded in at least one portion of an image and determining the relative position of the portion in the image, the at least one portion including a plurality of image elements, the apparatus comprising:
a mechanism that determines a first set of values of angular orientations of position modulation patterns in the elements of the at least one portion relative to a reference modulation pattern, the values corresponding to offsets between respective position center points about which the position modulation patterns are radially symmetrical and a center point of a reference axis in the at least one portion, the reference axis being associated with the reference modulation pattern, the reference modulation pattern and the position modulation patterns being produced by applying modulations to a characteristic of the elements; and
a decoder for determining the position in the image of the at least one portion based on the first set of angular orientation values.

17. Apparatus of claim 16 wherein
the mechanism further determines a second set of values of angular orientations of data modulation patterns in the elements relative to the reference modulation pattern, the values corresponding respectively to one or more data symbols; and
the decoder further assigns the one or more data symbols to the respective angular orientations and arranges the symbols in order according to the frequencies associated with the respective data modulation patterns to reproduce a data message and error correction information and the decoder determines that the reference orientation is correctly identified if after manipulation of the data symbols the data message is error-free.

18. Apparatus according to claim 15, wherein the characteristic comprises intensity values of the elements.

19. Apparatus according to claim 17, wherein the characteristic comprises intensity values of the elements.

20. Apparatus according to claim 15, wherein at least one of the reference and the data modulation patterns comprises a linear sinusoidal modulation pattern of the characteristic.

21. Apparatus according to claim 17, wherein at least one of the reference and the data modulation patterns comprises a linear sinusoidal modulation pattern of the characteristic.

22. Apparatus according to claim 15, wherein the position modulation pattern has a higher spatial frequency than any of the reference and the data modulation patterns.

23. Apparatus according to claim 15, wherein certain or all of the position modulation patterns have identical spatial frequencies.

24. Apparatus according to claim 17, wherein the position modulation patterns have higher spatial frequencies than any of the reference and the data modulation patterns.

25. Apparatus according to claim 17, wherein certain or all of the position modulation patterns have identical spatial frequencies.

26. Method according to claim 1, wherein certain or all of the position modulation patterns have identical spatial frequencies.

27. Computer-readable memory comprising computer-executable program instructions for use in encoding position-related information in at least one portion of an image, the at least one portion including a plurality of image elements, the instructions, when executed, causing:
determining a reference modulation pattern to be applied to a characteristic of the elements, the reference modulation pattern having a reference angular orientation and a reference frequency;
determining at least two position modulation patterns having the same or different frequencies, the position modulation patterns being radially symmetrical about respective center points having predetermined locations; and
modifying the characteristic of the image elements in accordance with a coded pattern that is a combination of the reference modulation pattern and the position modulation patterns.

28. Computer-readable memory comprising computer-executable program instructions for use in decoding position-related information encoded in at least one portion of an image, the at least one portion including a plurality of image elements, the instructions, when executed, causing:
determining in a coded pattern in the elements a reference modulation pattern that is associated with a reference angular orientation and a reference frequency and defines a reference axis;
determining in the coded pattern two or more position modulation patterns that are associated with one or more frequencies and are radially symmetrical about respective position center points having predetermined locations, the position modulation patterns having in the at least one portion respective angular orientations relative to the reference angular orientation that correspond to offsets between the respective position center points and a center of the reference axis; and
determining the relative position of the at least one portion based on the angular orientations.

29. Memory according to claim 27, wherein the characteristic comprises intensity values of the elements.

30. Memory according to claim 28, wherein the characteristic comprises intensity values of the elements.

31. Memory according to claim 27 wherein the instructions, when executed, further causing
determining in the coded pattern one or more data modulation patterns, the data modulation patterns having frequencies and angular orientations relative to the reference frequency and angular orientation that correspond to the respective data and error correction symbols, and
further modifying the characteristic of the image in accordance with a code pattern that includes the data modulation patterns.

32. Memory according to claim 28 wherein the instructions, when executed, further causing
determining for a given one of data and error correction symbols encoded into the at least one portion a data modulation pattern, the data modulation pattern having a frequency and an angular orientation relative to the reference angular orientation that corresponds to the given symbol,
associating respective symbol values with the angular orientations associated with the data modulation patterns,
arranging the symbols in accordance with the respective frequencies of the data modulation patterns to reproduce the data and error correction symbols, and
determining that the reference axis associated with the reference modulation pattern is correctly identified if error-free data is available after manipulation of the reproduced data and error correction symbols.

33. Memory according to claim 27, wherein the position modulation patterns are radially symmetrical sinusoidal modulation patterns of the characteristic.

34. Memory according to claim 28, wherein the position modulation patterns are radially symmetrical sinusoidal modulation patterns of the characteristic.

35. Memory according to claim 27, wherein the position modulation patterns have higher spatial frequencies than the reference pattern.

36. Memory according to claim 27, wherein at least certain of the position modulation patterns have identical spatial frequencies.

37. Method according to claim 2 further including
determining a second relative position based on the reference and angular orientations;
using the two relative positions to determine a relative direction of movement.

38. Method according to claim 2 further including
determining a second relative position based on the reference and angular orientations;
using the two relative positions to determine a relative distance or measurement.

39. Method according to claim 2 further including
determining a second relative position based on the reference and angular orientations;
Using the relative position information to direct a device to a designated position.
